(19) United States
(12) Patent Application Publication
(10) Pub. No.: US 2003/0201344 A1
(43) Pub. Date: Oct. 30, 2003

(54) Nozzle assembly for injecting fuel at multiple angles

(76) Inventor: Christopher Wark, Peoria, IL (US)

Correspondence Address: Michael B. McNeil, Liell & McNeil Attorneys PC, P.O. Box 2417, Bloomington, IN, 47402, US

(21) Appl. No.: 10/122,854

(22) Filed: Apr. 15, 2002

(51) Int. Cl. F02M 47/02

(52) U.S. Cl. 239/533.8

(57) ABSTRACT

A nozzle assembly includes a nozzle body with a valve seat and a nozzle member that is partially positioned within the nozzle body. At least one of the nozzle member and the nozzle body defines a supply passage. There is a segment of the supply passage positioned above the valve seat and has a spiral shape. The nozzle member moves between a first position, a second position, and a third position. When the nozzle member is in the first position, a lower portion of the nozzle member is in contact with the valve seat and the supply passage is closed. When the nozzle member is in the second position and the third position, a lower portion of the nozzle member is out of contact with the valve seat and the supply passage is opened. When the nozzle member is in the second position, fuel is injected at a relatively high included angle. When the nozzle member is in the third position, fuel is injected at a relatively low included angle.

### TECHNICAL FIELD

This invention relates generally to fuel injectors, and more specifically to nozzle assemblies with the ability to inject fuel in more than one spray pattern.

### BACKGROUND

Engineers are constantly seeking ways to reduce undesirable engine emissions. One strategy is to seek ways to improve performance of fuel injection systems. In the past, fuel systems were not electronically controlled and were designed to function in diesel engines operating only in a conventional mode. In order for the engine to operate in the conventional mode, a fuel injector was often operably coupled to the cam shaft such that the rotation of the cam shaft resulted in the fuel being injected into the engine cylinder near top dead center in a compression stroke. Over time, engineers learned that the performance of the fuel injection system could be enhanced by electronically controlling the timing and the quantity of the fuel injection. The ability to electronically control the timing and quantity of the fuel injection lead to the development of Homogeneous-Charged Compression Ignition, herein referred to as HCCI. HCCI is a mode of engine operation in which the timing of the fuel injection is controlled such that injection occurs early in the compression stroke. Fuel is injected into the engine cylinder when the piston is farther from top dead center in the compression stroke, resulting in better mixing of fuel and air, and a more complete burn of the fuel.

Although engineers have found that HCCI has lead to significant reductions in undesirable emissions at low engine speeds and loads, they have also found that HCCI is incompatible with engines operating at high speeds and loads. Thus, the conventional mode of operation must still be used for engines operating at high loads and speeds. In order to maximize the reduction of undesirable emissions and to operate the engine at all speeds and loads, the fuel system needs the ability to function in the engine operating in the HCCI and the conventional mode.

Over the years, engineers have also come to learn that the more evenly fuel is dispersed within the engine cylinder upon injection, the more completely the fuel will burn, thereby reducing emissions. The angle at which the fuel is injected affects the uniformity of the fuel and air mixture within the engine cylinder. In the engine operating in HCCI mode, the fuel is injected when the engine piston is closer to bottom dead center, and there is relatively low pressure within the engine cylinder. In order to achieve maximum uniformity of fuel and air mixture, the fuel should be injected at a relatively low angle. In the engine operating in the convention manner, the fuel is injected when the engine piston is closer to top dead center in the compression stroke, and there is relatively high pressure within the engine cylinder. Moreover, there is little empty space between the advancing piston and the top of the cylinder. In order to avoid impingement of the injected fuel with the piston, the fuel should be injected at a relatively high angle. Thus, in order to achieve the greatest reduction in undesirable emissions by injecting fuel in both HCCI and conventional operation modes, the fuel system should have the capability to inject fuel into the engine cylinders at differing angles depending on the timing of the injections.

Engineers have used varying methods to inject at different angles. For instance, fuel injectors such as that shown in U.S. Pat. No. 3,339,848 issued to Eugene J. Geiger on Sep. 5, 1967, utilize two valves controlling the flow of fuel through two outlet passages. Each outlet passage injects fuel into the engine cylinder at different angles. However, the Geiger fuel injector is not electronically controlled and is not directed at overcoming the problems associated with operating the fuel system within the engine operating in both the HCCI and conventional manner. Another method of injecting fuel at different angles and spray patterns is to provide two fuel injectors, each injecting fuel at different angles, for one engine cylinder. The operating load and speed will dictate which injector will be used. Although utilizing two fuel injectors for each cylinder may provide two different spray patterns, there are problems associated with using two injectors. For instance, it is known in the art that a reduction in the number of engine components can make the engine more robust. Moreover, the additional fuel injector will increase the expense of manufacturing and assembling the fuel system.

The present invention is directed to overcoming one or more of the problems set forth above.

### SUMMARY OF THE INVENTION

In one aspect of the present invention, a nozzle assembly includes a nozzle body that has a valve seat. A nozzle member is at least partially positioned within the nozzle body and moves between a first position and a second position. At least one of the nozzle body and the nozzle member defines a supply passage. A segment of the supply passage positioned above the valve seat has a spiral shape. When the nozzle member is in the first position, the supply passage is closed. When the nozzle member is in the second position, the supply passage is open.

In another aspect of the present invention, a fuel injector has an injector body that includes a nozzle body. A nozzle member is at least partially positioned within the nozzle body and moves between a first position, a second position, and a third position. A lower portion of the nozzle member is positioned below a valve seat of the nozzle body. At least one of the nozzle body and the nozzle member defines a supply passage. When the nozzle member is in the first position, the nozzle member is in contact with the valve seat and the supply passage is closed. When the nozzle member is in the second position, the nozzle member is out of contact with the valve seat and a spray pattern is in a pressure-swirl atomization configuration. When the nozzle member is in the third position, the nozzle member is out of contact with the valve seat and the spray pattern is in a pressure atomization configuration.

In yet another aspect of the present invention, there is a method of injecting fuel. A nozzle member is at least partially positioned within a nozzle body such that it moves between a first position, a second position, and a third position. In order to prevent fuel injection, at least in part, the nozzle member is moved to the first position that closes a supply passage. In order to inject fuel at a relatively high included angle, at least in part, the nozzle member is moved to the second position that swirls fuel in the supply passage above the valve seat. In order to inject fuel at a relatively low included angle, at least in part, the nozzle member is moved to the third position that restricts flow of fuel in the supply passage between the nozzle member and the nozzle body.

### BRIEF DESCRIPTION OF THE DRAWINGS

FIG. 1 is a sectioned side diagrammatic view of a fuel injector according to the present invention;

FIG. 2 is a sectioned side diagrammatic representation of the nozzle assembly of the fuel injector of FIG. 1 in a pressure-swirl atomization configuration; and

FIG. 3 is a sectioned side diagrammatic representation of the nozzle assembly of the fuel injector of FIG. 1 in a pressure atomization configuration.

### DETAILED DESCRIPTION

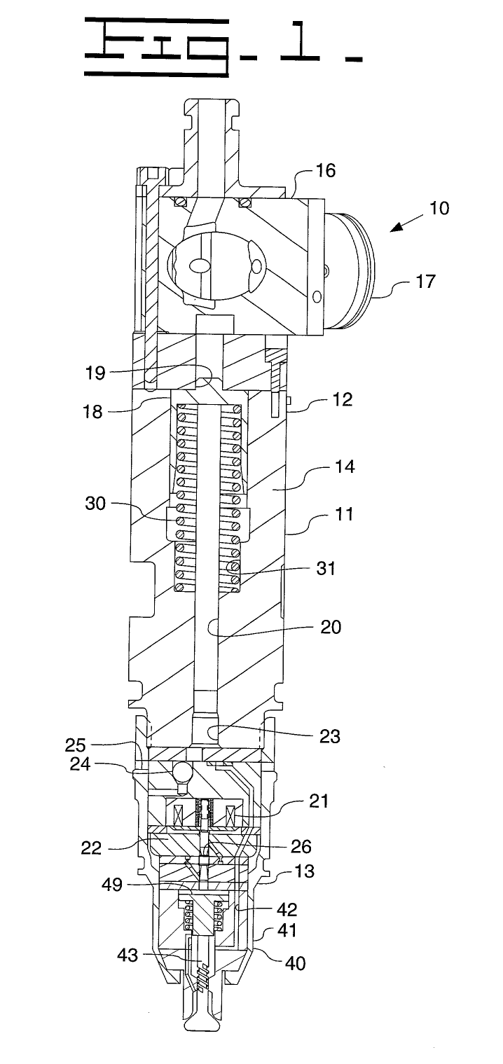

Referring to FIG. 1, there is shown a section side diagrammatic view of a fuel injector 10 according to the present invention. The fuel injector 10 includes an injector body 11 that can be thought of as including an upper portion 12 and a lower portion 13. In the fuel injector 10 illustrated, a fuel pressurization assembly 14 is located in the upper portion 12, whereas a nozzle assembly 40 is located in the lower portion 13. Although the fuel injector 10 shows the fuel pressurization assembly 14 and the nozzle assembly 40 joined into a unit injector 10, those skilled in the art will appreciate that those respective assemblies could be located in separate bodies connected to one another with appropriate plumbing. It should also be appreciated that fuel pressurization assemblies having varying operating methods could be attached to the nozzle assembly 40. The upper portion 12 of the injector body 11 includes a pressure intensifier 18 and a flow control valve 16, which is operably coupled to an electrical actuator 17. Other fuel pressurization strategies, such as a common rail or cam actuation, are compatible with the nozzle assembly 40 of the present invention. The lower portion 13 of the injector body 11 includes the nozzle assembly 40 and a needle control valve 22 that is operably coupled to an electrical actuator 21, which is also located in, and attached to, lower portion 13.

Pressure intensifier 18 includes a stepped top intensifier piston 19 and preferably a free floating plunger 20. Intensifier piston 19 is biased to its retracted position, as shown, by a return spring 30. The stepped top of intensifier piston 19 allows the initial movement rate, and hence possibly the initial injection rate, to be lower than that possible when the stepped top clears a counter bore. Return spring 30 is positioned in a piston return cavity 31, which is vented directly to the area underneath the engine's valve cover via an unobstructed vent passage. Free floating plunger 20 is biased into contact with the underside of intensifier piston 19 via low pressure fuel acting on one end in fuel pressurization chamber 23. Plunger 20 preferably has a convex end in contact with the underside of intensifier piston 19 to lessen the effects of a possible misalignment. In addition, plunger 20 is preferably symmetrical about three orthogonal axes such that fuel injector 10 can be more easily assembled by inserting either end of plunger 20 into the plunger bore located within injector body 11. When intensifier piston 19 is undergoing its downward pumping stroke, fuel within fuel pressurization chamber 23 is raised to injection pressure levels. Pressure intensifier 18 is driven downward when flow control valve 16 connects the fuel injector 10 to a source of high pressure actuation fluid. Between injection events, flow control valve 16 connects the fuel injector 10 to a low pressure reservoir, allowing the intensifier 18 to retract toward its upward position, as shown, via the action of return spring 30. The plunger 20 retracts due to fuel pressure acting on the underside of plunger 20. Thus, when pressure intensifier 18 is retracting, fresh fuel is pushed into fuel pressurization chamber 23 past a check valve 24 via a fuel inlet 25. When pressure intensifier 18 is driven downward, high pressure fuel in fuel pressurization chamber 23 can flow through the nozzle assembly 40 via a supply passage 42. The supply passage 42 is defined by at least one of a nozzle body 41 and a nozzle member 43. Nozzle member 43 is shown in its first or closed position.

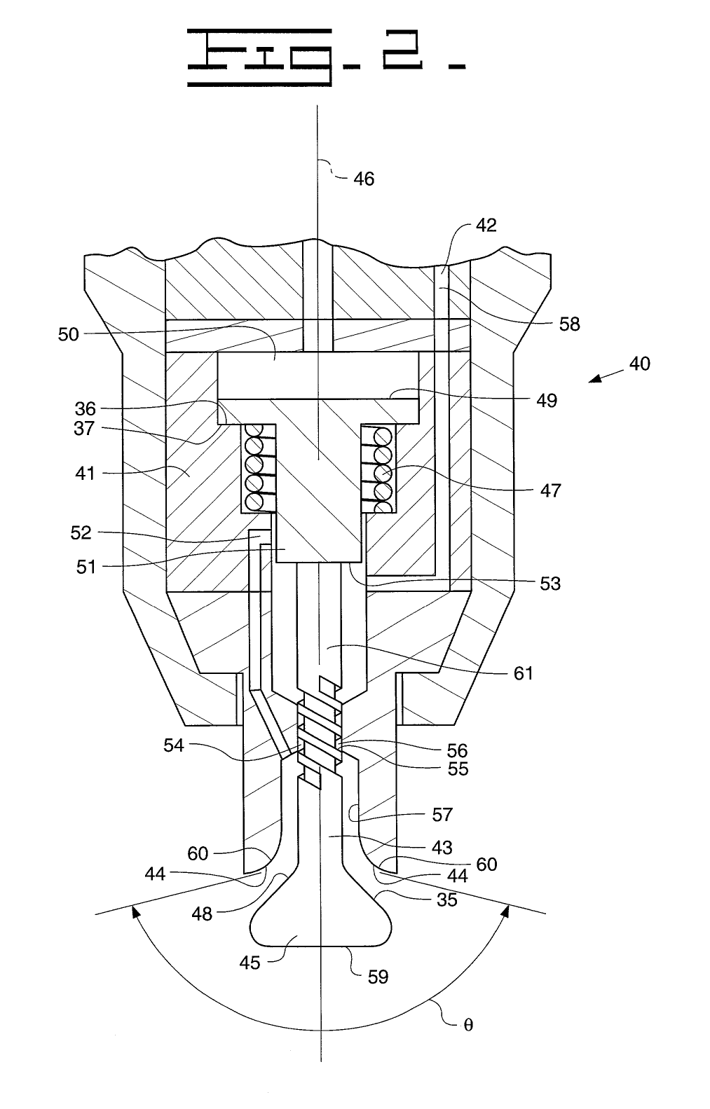

Referring to FIG. 2, there is a side diagrammatic view of the nozzle assembly 40 in which the nozzle member 43 is in a second position corresponding to a pressure-swirl atomization configuration. The supply passage 42 includes an upper portion 58, a bypass passage 52 and a segment 54 having a spiral shape. The nozzle assembly 40 includes the nozzle body 41 that has a valve seat 44 and the nozzle member 43 that is at least partially positioned with the nozzle body 41. The nozzle member 43 includes a control portion 51, a shaft 61, and a lower portion 35 that is positioned below the valve seat 44. During assembly, the shaft 61 is preferably screwed into the control portion 51 of the nozzle member 43. The lower portion 35 of the nozzle member 43 preferably includes a pintle 45. Those skilled in the art should appreciate that the term “pintle” is used to describe the lower portion 35 of a nozzle member shaped to cooperate with a valve seat and, in part, define a fuel spray pattern. The pintle 45 includes a closing pneumatic surface 59 which is exposed to pressure within the engine cylinder. The nozzle member 43 is moveable along a centerline 46 between a first position (as shown in FIG. 1) and a second position (as shown in FIG. 2). The nozzle member 43 is preferably biased to the first position by a biasing spring 47. As illustrated in FIG. 1, when in the first position, the nozzle member 43 is in contact with the valve seat 44 and closes the supply passage 42. Thus, fuel injection is prevented. As illustrated in FIG. 2, when in the second position, the nozzle member 43 is out of contact with the valve seat 44, and the supply passage 42 is open. Thus, fuel injection can occur.

The movement of the nozzle member 43 between the first position and the second position is preferably controlled, at least in part, by exposing a second hydraulic opening surface 49 of the nozzle member 43 to pressure within a control chamber 50. However, it should be appreciated that there are other methods of controlling the movement of the nozzle member 43, including, but not limited to, a stepper motor or possibly a valve controlling a moveable hydraulic stop. The needle control valve 22 (shown in FIG. 1) preferably controls the pressure acting on the second hydraulic surface 49. The needle control valve 22 includes a control valve member 26 that is moveable between a first position and a second position. When a control valve member 26 of the needle control valve 22 is in a first position, there is low pressure from the fuel supply inlet 25 acting on the second opening hydraulic surface 49 of the nozzle member 43. Because the low pressure is insufficient to overcome the bias of the spring 47, the nozzle member 43 will remain in the first position in contact with the valve seat 44 and closing the supply passage 42, as long as there is no pressurized fuel within the supply passage 42. When the control valve member 26 is in a second position, the needle control valve 22 fluidly connects the control chamber 50 to the supply passage 42. When there is low pressure within the upper portion 58 of the supply passage 42, low pressure is acting on the second opening hydraulic surface 49, and the nozzle member 43 does not advance against the action of the spring 47. However, when there is high pressure within the upper portion 58 of the supply passage 42, high pressure is acting on the second opening hydraulic surface 49 of the nozzle member 43. The high pressure is sufficient to advance the nozzle member 43 against the bias of the spring 47 until a stop surface 36 of the nozzle member 43 comes into contact with a stop 37 of the nozzle valve body 41. Thus, the nozzle member 43 moves out of contact with the valve seat 44. It should be appreciated that there are other means of stopping the nozzle member 43 at the second position when high pressure acts on the second opening hydraulic surface 49, such as providing an additional spring or balancing hydraulic pressure.

The control portion 51 of the nozzle member 43 blocks fluid communication between the upper portion 58 of the supply passage 42 and the bypass passage 52. It should be appreciated that the nozzle member 43 must also advance against the fuel pressure within supply passage 42 acting on a bottom side 53 of the control portion 51 of the nozzle member 43. Because the second opening hydraulic surface 49 includes a larger surface area than the bottom side 53 of the control portion 51, the pressure acting on the second opening hydraulic surface 49 can overcome both the bias of the spring 47 and the pressure within the supply passage 42.

Referring still to FIG. 2, the segment 54 of the supply passage 42 having the spiral shape is positioned above the valve seat 44. The segment 54 of the supply passage 42 having the spiral shape is preferably, defined in part, by at least one spiral groove 55 included in the shaft 51 of the nozzle member 43, although it should be appreciated that the spiral groove 55 could be included in the nozzle body 41. Preferably, the nozzle member 43 includes two spiral grooves 55, although any number could be used. Those skilled in the art should appreciate that the number of spiral grooves 55 preferred will depend on the amount of fuel passing through the fuel injector 10 and the desired spray pattern to be achieved. In addition, it should be appreciated that the angle of the spiral grooves 55 will affect the atomization of the fuel injected. The spiral grooves 55 of the nozzle member 43, at least in part, are located within a guide bore 56. The guide bore 56 is preferably created by narrowing the segment 54 of the supply passage 43 and partially positioning the spiral grooves 56 in the narrow segment 54. When the nozzle member 43 is in the second position, the spiral grooves 55 extend above and below the guide bore 56, establishing fluid communication between the guide bore 56 and the supply passage 43 below the valve seat 44 and the upper portion 58 of the supply passage 42. As the fuel is swirled through the spiral grooves 55, it gains angular momentum and is pushed to an outer surface 57 of the supply passage 42.

The supply passage 42 below the valve seat 44 includes a predetermined curvature 60 defining, at least in part, a spray angle. The predetermined curvature 60 is the curve which directs the injection of fuel at the desired angle into the engine cylinder. The predetermined curvature 60 of the supply passage 43 is defined by a predetermined curvature of the nozzle body 41 below the valve seat 44. The predetermined curvature 60 is illustrated as a 90° arc relative to the centerline 46. However, depending on the desired angle of injection, the predetermined curve 60 can have an angle less than 90° relative to the center line 46 and take varying shapes, such as elliptical or irregular curvature. The desired included angle of injection (θ) when the nozzle member 42 is in the second position is preferably greater than 90° . For instance, the predetermined curvature 60 of a 90° arc illustrated in the present invention directs the injection of fuel into the engine cylinder at an included angle of approximately 165°. Those skilled in the art appreciate that the “included angle” is the angle between the outermost points of the injection. When the nozzle member 43 is in the second position, fuel is being injected at a relatively high included angle (θ) compared to the angle in which fuel is injected when the engine is operating in HCCI mode. Thus, the fuel injector 10 is compatible with the engine operating in the conventional mode.

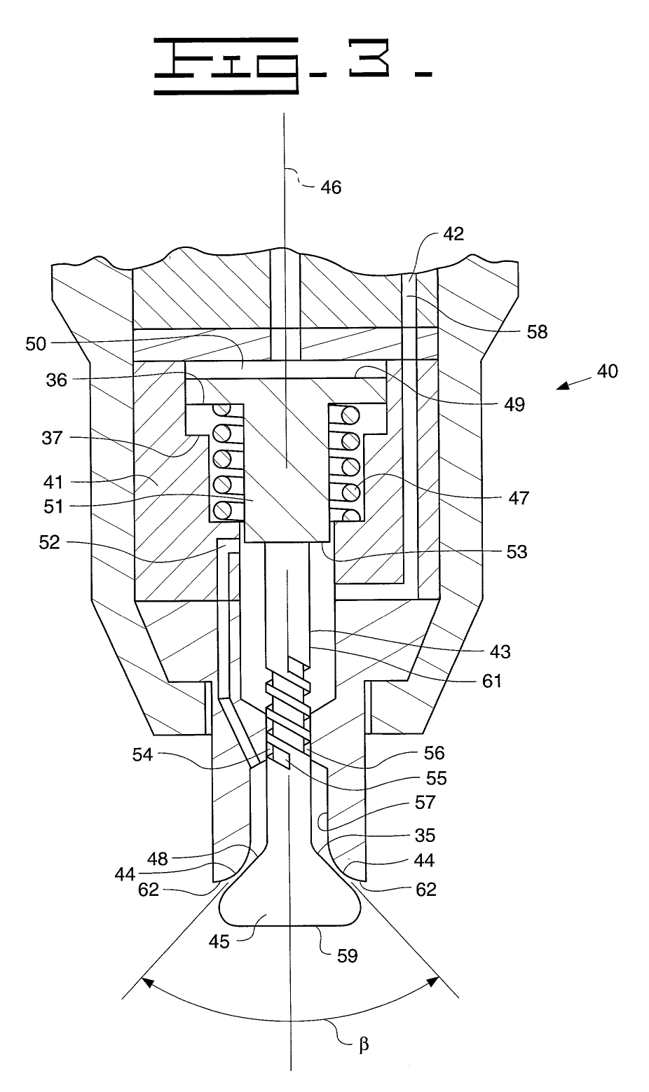

Referring to FIG. 3, there is shown a side diagrammatic view of the nozzle assembly 40 when the nozzle member 43 is in a third position. There is preferably a third position between the first position and the second position. When the nozzle member 43 is in the third position, there is low pressure acting on the second opening hydraulic surface 49 of the nozzle member 43. The low pressure cannot, alone, advance the nozzle member 43 against the action of the biasing spring 47 to a position where the stop surface 36 contacts the stop 47 of the nozzle body 41. Thus, the control portion 51 of the nozzle member 43 does not block fluid communication between the upper portion 58 of the supply passage 42 and the bypass passage 52. The bypass passage 52 is fluidly connected to the upper portion 58 of the supply passage 42 and the portion of the supply passage 42 below the guide bore 56. The spiral grooves 55 of the nozzle member 43 do not extend below the guide bore 56, and the guide bore 56 is blocked from fluid communication with the portion of the supply passage 42 below the valve seat 44.

The movement of the nozzle member 43 between the first position and the third position is preferably controlled, in part, by exposing a first hydraulic surface 48 of the nozzle member 43 to pressure within the supply passage 42. When the pressurized fuel flows through the bypass passage 52 to the portion of the supply passage 42 below the guide bore 56, the pressurized fuel acting on the first opening hydraulic surface 48 causes the pintle 45 to move out of contact from the valve seat 44. However, the pressure acting on the bottom surface 53 of the control portion 51 of the nozzle member 43 and the fact that low pressure is acting on the second opening hydraulic surface 49 balances the nozzle member 43 such that the bypass passage 52 remains in fluid communication with the supply passage 42. In other words, the combined forces on the first and second opening hydraulic surfaces 48 and 49, pneumatic surface 59 and the force of the spring 47 are balanced to produce the configuration shown. The pintle 45 and the valve seat 44 preferably define a restricted flow passage 62. By restricting the flow of fuel in the supply passage 42 below the valve seat 44, the flow of fuel is preferably directed by the angle of the pintle 45, resulting in a hollow cone spray, corresponding to a pressure atomization spray pattern. Thus, when the nozzle member 43 is in the third position, fuel is injected at a relatively low included angle (β) compared to the angle of injection when the engine is operating in the conventional mode. The fuel is preferably injected at an included angle (β) less than 90°. Thus, the fuel injector 10 is compatible with an engine operating in the HCCI mode.

Industrial Applicability

Referring to FIG. 1, there is shown a fuel injector 10 including a nozzle member 43 in the first position. Between injection events, flow control valve 45 connects the fuel injector 10 to the low pressure reservoir, allowing the pressure intensifier 18 to retract toward its upward position, as shown, via the action of spring 30 and fuel pressure acting on the underside of plunger 20. Thus, when the pressure intensifier 18 is retracting, fresh fuel is pushed into fuel pressurization chamber 23 past check valve 24 via fuel inlet 25. When the pressure intensifier 18 is in its retracted position, there is low pressure within the fuel pressurization chamber 23, and thus, the fuel will not be pushed into the nozzle supply passage 42. The first opening hydraulic surface 48 of the nozzle member 43 will not be exposed to pressurized fuel. Further, because the control valve member 26 is in its second position in which it fluidly connects the control chamber 50 to the upper portion 58 of the supply passage 42 which is currently at low pressure, the second opening hydraulic surface 49 is also not exposed to pressurized fuel. Because both the first opening hydraulic surface 48 and the second opening hydraulic surface 49 of the nozzle member 43 are exposed to low pressure, the pintle 45 of the nozzle member 43 remains in contact with the valve seat 44 and fuel injection is prevented.

Referring to FIG. 2, there is shown the nozzle assembly 40 in which the nozzle member 43 is in the second position. When an injection event is desired and the engine is operating in the conventional mode, such as when the vehicle or machinery is operating at relatively high speeds and loads, the electrical actuator 17 in the upper portion 12 of the fuel injector 10 will activate the flow control valve 16. The flow control valve 16 will fluidly connect the fuel injector 10 to the source of high pressure, causing the intensifier piston 19 and the plunger 20 to move against the action of the spring 30 and pressurize the fuel within the fuel pressurization chamber 23. When the fuel reaches injection pressure, the fuel will be pushed through the nozzle supply passage 42. The control valve member 26 will remain in its biased, second position, in which the needle control valve 22 fluidly connects the control chamber 50 to the upper portion 58 of the supply passage 42. The pressurized fuel within the upper portion 58 of the supply passage 42 will act on the second opening hydraulic surface 49 causing the nozzle member 43 to advance to the second position against the action of the biasing spring 47. The nozzle member 43 is also able to advance against the fuel pressure acting on the bottom surface 53 of the control portion 51 of the nozzle member 43, in part, because the surface area of the second opening hydraulic surface 49 is larger than the surface area of the bottom surface 53.

When the nozzle member 43 is in the second position, the control portion 51 of the nozzle member 43 blocks fluid communication between the bypass passage 52 and the upper portion 58 of the supply passage 42 and opens fluid communication between the spiral grooves 55 and the supply passage 42 below the valve seat 44. While the pressurized fuel flows through the spiral grooves 55 of the nozzle member 43, the fuel gains angular momentum, causing, in part, the fuel to atomize and to migrate to the outer surface 57 of the supply passage 42. Because the valve seat 44 is out of contact with the pintle 45 and the supply passage 42 is open, the fuel will flow along the outer surface 57 of the supply passage 42 that has a predetermined curvature 60 below the valve seat 44. The direction of the flow of fuel from the fuel injector 10 is defined, at least in part, by the predetermined curvature 60 of the nozzle body 41. The preferred predetermined curvature 60 of the 90° arc defines, in part, a fuel injection with the included angle (θ) of approximately 165°. However, the predetermined curvature 60 will vary depending on the desired angle at which the fuel is to be injected. For instance, if it were desirable to have the fuel injected at a lower included angle, the angle of the predetermined curvature 60 would be smaller than 90°. Further, it should be appreciated that the angle of injection can be altered by changing the shape of the predetermined curvature 60 below the valve seat 44. Overall, by moving the nozzle member 43 to the second position, in which the fuel is swirled, the fuel is injected at the relatively high included angle (θ). In addition, the pressure pushing the fuel through the nozzle supply passage 42 and the spiral grooves 55 results in an injection with a pressure-swirl atomization spray pattern.

The injection event is ended by de-energizing the electrical actuator 17, allowing the flow control valve 16 to move to a position that exposes the intensifier piston 19 to low pressure. This ceases the downward movement of the intensifier piston 19 and the plunger 20 allowing the fuel pressure to decay. Because the control chamber 50 is fluidly connected to the supply passage 42 by the needle control valve 22, the pressure within the supply passage 42 also acts on the second opening hydraulic surface 49 within the control chamber 50. When the fuel pressure in the supply passage 42 and the control chamber 50 drops below a pressure needed to overcome the spring 47, the nozzle member 43 will retract to its first position in which the pintle 45 is in contact with the valve seat 44. Pressure within the engine cylinder acts on the closing pneumonic surface 59 of the pintle 45 and assists in moving the nozzle member 43 into contact with the valve seat 44 and closing the supply passage 42. Thus, the nozzle member 43 is in the first position preventing fuel injection.

Referring to FIG. 3, there is shown the nozzle assembly 40 in which the nozzle member 43 is in the third position. When an injection event is desired and the engine is operating in HCCI mode, such as when the vehicle or machinery is operating at relatively low speeds and loads, the electrical actuator 17 in the upper portion 12 of the fuel injector 10 will activate the flow control valve 16. The flow control valve 16 will fluidly connect the fuel injector 10 to the source of high pressure, causing the pressure intensifier 18 to move against the action of the spring 30 and pressurize the fuel within the fuel pressurization chamber 23. Before the fuel reaches injection pressure, the electrical actuator 21 in the lower portion 13 of the fuel injector 10 will be energized, causing the control valve member 26 to move to its first position. When the control valve member 26 is in the first position, the control chamber 50 is fluidly connected to the fuel inlet 25 which is at low pressure. Therefore, low pressure is acting on the second opening hydraulic surface 49. When the fuel reaches injection pressure, the fuel will be pushed through the nozzle supply passage 42. Even though the surface area of the second opening hydraulic surface 49 is larger than the surface area of the boom surface 53 of the control portion 51, the low pressure acting on the second opening hydraulic surface 49 is insufficient to overcome the bias of the spring 47 and the fuel pressure acting on the bottom surface 53 of the control portion 51. The control portion 51 of the nozzle member 43 does not advance to block fluid communication between the upper portion 58 of the supply passage 42 and the bypass passage 52. Further, because the low pressure acting on the second opening hydraulic surface 49 does not advance the nozzle member 43, the guide bore 56 having the spiral shape is blocked from fluid communication with the supply passage 43 below the valve seat 44. Thus, the pressurized fuel flowing through the supply passage 43 cannot flow through the spiral grooves 55 of the nozzle member 43. Rather, the fuel flows from the supply passage 42 to the bypass passage 52. It should be appreciated that more than one bypass could be used to affect the spray pattern. It should also be appreciated that the angle at which the bypass passage 52 is connected to the supply passage 42 below the guide bore 56 can atomize the fuel differently. For instance, by directing the bypass passage 52 such that the pressurized fuel has a bouncing effect when it hits the nozzle member 43 can create an impingement atomization. Further, it should be appreciated that there are varying methods, other than the bypass passage 52, that can provide two flow paths through the nozzle body 41, one including the segment 54 with the spiral shape and the other not including the spiral shape.

The pressurized fuel flowing from the bypass passage 52 to the supply passage 42 below the guide bore 56 acts on the first opening hydraulic surface 48 of the nozzle member 43, causing the nozzle member 43 to advance. However, the pressure acting on the first opening hydraulic surface 48 is advancing the nozzle member 43 against the bias of the spring 47, the pressure acting on the bottom surface 53 of the control portion 51 and the pressure from within the engine cylinder acting on the closing pneumatic surface 59 of the nozzle member 43. Thus, the pressure on the first opening hydraulic surface 48 advances the nozzle member 43 to the second position, which is the intermediate position. In the second position, the nozzle member 43 is advanced far enough that the pressurized fuel can flow from the fuel injector 10 through the restricted flow area 62 that is defined by the nozzle body 41 below the valve seat 44 and the pintle 45. Further, the low flow rate of the pressurized flowing from the bypass passage 52 to the supply passage 42 below the guide bore 56 causes an annular flow around the pintle 45 in the conventional hollow cone spray pattern. The restricted flow area 62 directs the flow of the fuel around the pintle 45 and into the engine cylinder. Due, in part, to the shape of the pintle 45, the fuel is injected at the relatively low included angle (β). Those skilled in the art will appreciate that the low angle at which the fuel is injected can be altered by changing the shape of the pintle 45 without sacrificing the pintle's ability to conform to the valve seat 44. In the present invention, the fuel is preferably injected at an included angle (β) less than 90°. Further, those skilled in the art will recognize this method of atomization while the nozzle member 43 is in the third position as pressure atomization.

To end the injection event, the electrical actuator 17 in the upper portion 12 of the fuel injector 10 is de-energized, causing the flow control valve 16 to fluidly connect the fuel injector 10 to the low pressure reservoir. This results in the intensifier piston 19 and plunger 20 slowing, stopping and reversing direction. A combination of the slowing intensifier piston 19 and plunger 20 and the fuel injection cause the fuel pressure to drop. The fuel pressure eventually falls below the nozzle valve opening pressure defined by the spring 47, causing the nozzle member 43 to retract to its first position in which the pintle 45 is in contact with the valve seat 44. After the nozzle member 43 closes the supply passage 42 or after the pressure within the supply passage 42 drops below the nozzle valve opening pressure, the electrical actuator 21 in the lower portion 13 of the fuel injector 10 is de-energized, causing the needle valve member 26 to move to its second position in which the supply passage 42 is in fluid communication with the control chamber 50. Because there is no longer pressurized fuel being pushed through the upper portion 58 of the supply passage 42, the control chamber 50 will be fluidly connected to low pressure within the supply passage 42. Further, because there is no longer pressurized fuel within the supply passage 42, there is low pressure acting on the first opening hydraulic surface 48, allowing the nozzle member 43 to retract under the action of the spring 47 to its first, or closed, position, in which the pintle 45 is in contact with the valve seat 44. Pressure within the engine cylinder acts on the closing pneumonic surface 59 of the pintle 45 and assists in moving the nozzle member 43 into contact with the valve seat 44 and closing the supply passage 42. Thus, the nozzle member 43 will prevent fuel injection.

Overall, the present invention is advantageous because it provides one fuel injector 10 that can inject fuel at two different angles, the relatively high included angle (θ) and the relatively low included angle (β). Because the fuel injector 10 can inject fuel at varying angles, the fuel injector 10 provides for two modes of engine operation: HCCI and conventional, or even a mixed mode of both HCCI and conventional. When the engine is operating in HCCI mode, the fuel injector 10 injects fuel earlier in the compression stroke. Because there is a larger space between the piston and the top of the cylinder at the point of injection, the fuel is injected at the relatively low included angle (β) in order to achieve a uniform mixture of air and fuel within the cylinder. By injecting the fuel early in the compression stroke and at the relatively low included angle (β), the fuel bums more completely, thereby, reducing undesirable emissions. On the other hand, when the vehicle or machinery is operating at high speeds and loads, the engine can operate in the conventional mode, in which the fuel injector 10 injects fuel closer to top dead center in the compression stroke. Because there is a small volume of compressed air within the cylinder at the point of injection, the fuel is injected at the relatively high included angle (θ) in order to avoid impingement of the fuel with the piston. When the vehicle or machinery is operating at moderate speeds and loads, the engine could operated in the mixed mode of both HCCI and convention. Thus, the fuel injector 10 would split the injection between a first shot of fuel earlier in the compression stroke and at the relatively low included angle (β) and a second shot of fuel later in the compression stroke and at the relatively high included angle (θ).

The present invention is further advantageous because it provides fuel injections at varying angles without utilizing multiple fuel injectors per cylinder or an increased number of fuel injector components, thereby reducing the costs of manufacturing. Further, by recognizing the variables that affect the angle and the atomization of the injection, such as the predetermined curvature 60 below the valve seat, the angle and number of the spiral grooves 55, the restricted flow area 62, and the angle at which the bypass passage 52 is connected to the supply passage 42 below the guide bore 56, the ideal nozzle assembly 40 can be determined for engines of varying sizes and varying types. In addition, the nozzle assembly 40 can be used with different fuel pressurization assemblies, including cam driven injectors and common rail injection systems.

It should be understood that the above description is intended for illustrative purposes only, and is not intended to limit the scope of the present invention in any way. Thus, those skilled in the art will appreciate that other aspects, objects, and advantages of the invention can be obtained from a study of the drawings, the disclosure and the appended claims.

What is claimed is:

1. A nozzle assembly comprising:
a nozzle body including a valve seat;
a nozzle member at least partially positioned within the nozzle body and being moveable between a first position and a second position;
at least one of the nozzle body and the nozzle member defining a supply passage;
a segment of the supply passage having a spiral shape positioned above the valve seat; and
the supply passage is closed when the nozzle member is in the first position; and the supply passage is open when the nozzle member is in the second position.

2. The nozzle assembly of claim 1 wherein the segment of the supply passage having the spiral shape includes the nozzle member defining at least one spiral groove.

3. The nozzle assembly of claim 2 wherein the spiral groove is at least partially located in a guide bore defined by the nozzle body.

4. The nozzle assembly of claim 1 wherein a lower portion of the nozzle member has a closing pneumatic surface exposed outside the nozzle body.

5. The nozzle assembly of claim 4 wherein the lower portion of the nozzle member includes a pintle.

6. The nozzle assembly of claim 1 wherein the nozzle member is biased to the first position by a biasing spring.

7. The nozzle assembly of claim 1 wherein a segment of the supply passage below the valve seat has a predetermined curvature defining, at least in part, a spray angle.

8. The nozzle assembly of claim 1 wherein the nozzle member has a third position between the first position and the second position.

9. The nozzle assembly of claim 8 wherein the nozzle member having a first opening hydraulic surface exposed to pressure within the supply passage and a second opening hydraulic surface exposed to pressure within a control chamber.

10. The nozzle assembly of claim 8 including a pressure-swirl atomization configuration when the nozzle member is in the second position; and
a pressure atomization configuration when the nozzle member is in the third position.

11. A fuel injector comprising:
an injector body including a nozzle body that includes a valve seat;
a nozzle member being at least partially positioned in the nozzle body and including a lower portion being positioned below the valve seat;
a supply passage being defined by at least one of the nozzle body and the nozzle member; and
the nozzle member being movable along a centerline between a first position, a second position, and a third position; the nozzle member is in contact with the valve seat and the supply passage is closed when in the first position; the nozzle member is out of contact with the valve seat in a pressure-swirl atomization spray pattern when in the second position; and the nozzle member is out of contact with the valve seat in a pressure atomization spray pattern when in the third position.

12. The fuel injector of claim 11 wherein the supply passage includes a segment having a spiral shape positioned above the valve seat.

13. The fuel injector of claim 12 wherein the segment of the supply passage having the spiral shape includes the nozzle member defining at least one spiral groove.

14. The fuel injector of claim 13 wherein the spiral groove is at least partially located in a guide bore defined by the nozzle body.

15. The fuel injector of claim 11 wherein the lower portion of the nozzle member includes a pintle having a closing pneumatic surface.

16. The fuel injector of claim 11 wherein the nozzle member is biased to the first position by a biasing spring.

17. The fuel injector of claim 11 wherein the supply passage below the valve seat has a predetermined curvature defining, at least in part, a spray angle.

18. The fuel injector of claim 11 wherein the nozzle member has a first opening hydraulic surface exposed to pressure within the supply passage and a second opening hydraulic surface exposed to pressure within a control chamber.

19. The fuel injector of claim 18 including a needle control valve attached to the fuel injector body and including a control valve member; and
the control valve member being moveable between a first position and a second position; the control chamber is fluidly connected to a low pressure passage when in the first position; and the control chamber is fluidly connected to a high pressure passage when in the second position.

20. A method of injecting fuel comprising the steps of:
providing a nozzle member at least partially positioned within a nozzle body and moveable between a first position, a second position, and a third position;
preventing fuel injection, at least in part, by moving the nozzle member to the first position that closes a supply passage;
injecting fuel at a relatively high included angle, at least in part, by moving the nozzle member to the second position and swirling fuel in the supply passage above the valve seat; and
injecting fuel at a relatively low included angle, at least in part, by moving the nozzle member to the third position and restricting flow of fuel in the supply passage between the nozzle member and the nozzle body.

21. The method of claim 20 wherein the high included angle is greater than 90°.

22. The method of claim 20 wherein the low included angle is less than 90°.

23. The method of claim 20 wherein the step of injecting fuel at the relatively high included angle includes a step of shaping a segment of the supply passage below the valve seat to have a predetermined curvature at least in part, by shaping the nozzle body below the valve seat to have a predetermined curvature.

24. The method of claim 20 wherein the step of injecting fuel at the relatively high included angle includes a step of applying relatively high pressure on a control hydraulic surface of the nozzle member.

25. The method of claim 24 wherein the step of applying includes a step of fluidly connecting a control chamber to a source of relatively high pressure.

26. The method of claim 20 wherein the step of injecting fuel at the relatively low included angle includes a step of exposing an opening hydraulic surface of the nozzle member to pressure in the supply passage; and
exposing a control hydraulic surface of the nozzle member to relatively low pressure by moving a needle control valve member from a second position to a first position.
